(19) United States
(12) Patent Application Publication
(10) Pub. No.: US 2024/0423850 A1
(43) Pub. Date: Dec. 26, 2024

(54) SELF LOADING SYSTEM FOR POWER MOBILITY SCOOTERS / WHEELCHAIRS

(71) Applicants: Barry Lynn Butler, Solana Beach, CA (US); Brett Louis Butler, Encinitas, CA (US)

(72) Inventors: Barry Lynn Butler, Solana Beach, CA (US); Brett Louis Butler, Encinitas, CA (US)

(21) Appl. No.: 18/213,094

(22) Filed: Jun. 22, 2023

(51) Int. Cl. A61G 3/06

(52) U.S. Cl. CPC A61G 3/062

(57) ABSTRACT

A self-lifting system for an electric mobility scooter or wheel chair into a vehicle, using only the mobility units electric motor, controls, and battery. The system uses two tension straps or ropes, attached inside a vehicle with the other end attached to capstans on the powered wheels. The forward/reversing switch allow the capstan to wind/unwind the rope or strap lifting or lowering of the mobility unit with or without ramps, with the user applying no lifting load with ramps or only small lifting and balancing loads without ramps. Only tension members and anchors are required in the vehicle.

### PRIOR ART

As the population ages many seniors need some sort of mobility aids to help them and their packages get around, because their legs are weaker and may not let them walk longer distances independently. Battery powered wheelchairs, mobility scooters and powered hand trucks are widely used. These powered mobility units weigh between 15 to 30 kg (30 to 60 pounds) a young strong person can easily lift them into the vehicle or trunk of a car, but seniors are not usually strong enough to so. Hence many seniors require an auxiliary power lifting device, such as a scissor jack, external lift or vehicle mounted lift to lift their mobility device into the vehicle, or hitch mounted carrier. These lift systems have electric motors to power a lifting mechanism. These lifting systems take up space in or on the vehicle when not transporting a mobility device, and require permanent attachment to the vehicle and must connection to the car battery for power. The present invention uses the electric motor and battery resident on the mobility device to lift itself into vehicles taking up a very small amount of cargo space when the mobility device is not present.

### BACKGROUND OF INVENTION

As more people need mobility devices, they have become lighter and foldable for transport in cars and on airplanes as luggage, they fold up to about 61 cm×76 cm×30 cm (24 in.×30 in.×12 in.). Powered mobility devices have a battery and either a single motor powering both wheels with gears and a differential or two independent motors, one for each drive wheel. These mobility devices can propel a 150 kg (300 pound) person up an incline of 8-10 degrees. This requires the motors to deliver between 200 to 300 inch pounds of torque to the drive wheels, depending on wheel diameter. This is sufficient torque to lift a 50 kg (100 pound) mobility device vertically. The 1 to 1.5 m (3 to 4 foot) vertical lift takes very little power from the battery capable of miles of horizontal and uphill travel. This invention is based on the realization that the mobility device motor/motors can lift the mobility device with battery into a vehicle by itself, without any external lift motors and/or car power. The handicapped person only needs to work the motor control and guide the mobility device requiring less than 5 kg (10 pounds) of balancing force, since the motor/battery are the heaviest parts of the mobility device and are near the end which is being lifted by the capstans with cable, ropes, or straps. Battery powered hand trucks could load packages in vehicles using the same self-lifting technology.

### SUMMARY OF INVENTION

The invention consists of a capstan mounted on the inside or outside of each drive wheel, and a rope or strap that is anchored in the vehicle and can be attached to and wound in or out on the capstan by running the mobility device motor forward or reverse with its own battery and controller. Short ramps may be used for unfolded scooters and wheelchairs. No ramps would be needed for scooters and wheelchairs that fold for airline travel or compact storage. The actual tire may be modified to be its own capstan with suitable wide strapping and strap centering devices. The drive wheels in one direction while loading, and the opposite direction while unloading. This eliminates the need permanent mounting of a lifting device in the vehicle. Most cars and SUVs have hooks for attaching infant car seats where the tension rope/straps can be secured. The strap/rope can be attached by wrapping it around the back seat in many vehicles with split back seats. These ropes and straps can be easily put out of the way and not interfere with the use of the cargo space. Some trucks may have to add small anchors in the bed, which would not interfere with other payloads. The addition of the capstan on the outside of the wheels adds about 2.5 cm (1 inch) on each side of the mobility device. Demountable capstans and capstans on the inside of the wheels or tire as capstan adds no width to the mobility device when it is out of the vehicle and in use. The add on, non-demountable capstans add about 1 kg (2.2 pounds) to the weight. The capstans can be easily attached via a detachable cam and twist lock mechanism; hence mobility device width would not be increased when lift system is not in use.

Typical use of the self-lifting mobility device. Device must be fitted with drive wheel mounted capstans. Straps/ropes must be installed around a seat or child seat anchors in the vehicle, along with a rug or mat that can protect the vehicle's bumper. The handicapped person drives the scooter/wheel chair to the back of the vehicle. The person gets off the device and folds it to airline travel position, for some larger SUVs folding may not be required. Then positions the axle parallel to the bumper and puts in place the bumper protector. Then attaches the two straps/ropes to capstan by sliding into the slots provided. If demountable capstans are used then the capstan already attached to the straps/ropes must be locked on each drive wheel. Then the person must operate the reverse motor control switch and apply a small, approximately 4 kg (9 pound), balancing force. The mobility device will now climb up the tension members as the capstans wind up the tension members when the mobility device gets over the bumper, it will roll on its wheels into the back of the SUV or trunk, causing slack in the tension members which is taken up by bungee cords, so the tension members do not get tangled. Now the person gets into the vehicle, closes the hatchback or trunk, and drives to the destination. At the destination the whole process is reversed. Trunk is opened, bumper protection put in place, forward switch activated, mobility device drives off back bumper now held up by tension members and balanced by person while descending to the pavement. Once on pavement tension members disconnected. Device unfolded for local travel, like store or restaurant. If going on an airline, airlines take the folding scooters and wheelchairs at the departing gate, and return them to the passenger at the destination gate. Then the handicapped person can go to the rental car lot and rent a car carrying along only the capstans and tension straps that fit in a 30 cm×17 cm×5 cm (12″×7″×2″) case to attach to the anchors or seat in the rental car. This is a convenience not available in other mobility device lifting systems which are bulky and weigh 10 kg (24 pounds) and must go as luggage on airline travel.

Additional objectives, advantages and novel features of the invention will be set forth in part in the description which follows and in part will become apparent to those skilled in the art upon examination of the following. In particular, the battery, drive wheel electronic control system that manages the drive motor rotation to power the mobility device lift and descent on tension members spooled by the capstans and anchored in the vehicle. Others may be learned by practice of the invention. The objectives and advantages of the invention may be realized and attained by means of the instrumentalities and combinations particularly pointed out in the appended claims.

### BRIEF DESCRIPTION OF DRAWING

FIG. 1A schematic of the tension member attachment in the vehicle and quick attach and release slot to demountable capstan cam and twist lock mounted on back plates to both drive wheels and shows one type of Clockwise (CW) and Counter Clockwise (CCW) cam and twist locking mechanism.

FIG. 2 Shows the drive wheel tension member connections which do not add width to the mobility device including: drive wheel using a strap and segmented clips and wheel clamp; the back plate mounted, cam detachable capstan; bolt on capstan on the inside, motor side, of the wheel.

FIG. 3 Depicts the demountable capstans with their mounting plates tied to the external and internal threaded axle shafts which include hub motors and capstans fix mounted on the outside of the wheel spokes, which increases mobility device width.

FIG. 4 Depicts mobility scooter, wheelchair and hand truck electric drive units showing both open for use and folded for easy vehicle loading or airplane transport.

FIGS. 5A & B Both show the self-lifting system loading folded and unfolded scooters, wheelchairs and hand trucks into and out of a vehicle or SUV, with and without ramps.

FIG. 6 Shows centering cam and twist lock plate to the wheel, using bolt pattern prior to tightening and direct capstan to wheel bolting with locking sliders and break out washers prior to bolt tightening.

### DETAILED DESCRIPTION OF THE INVENTION

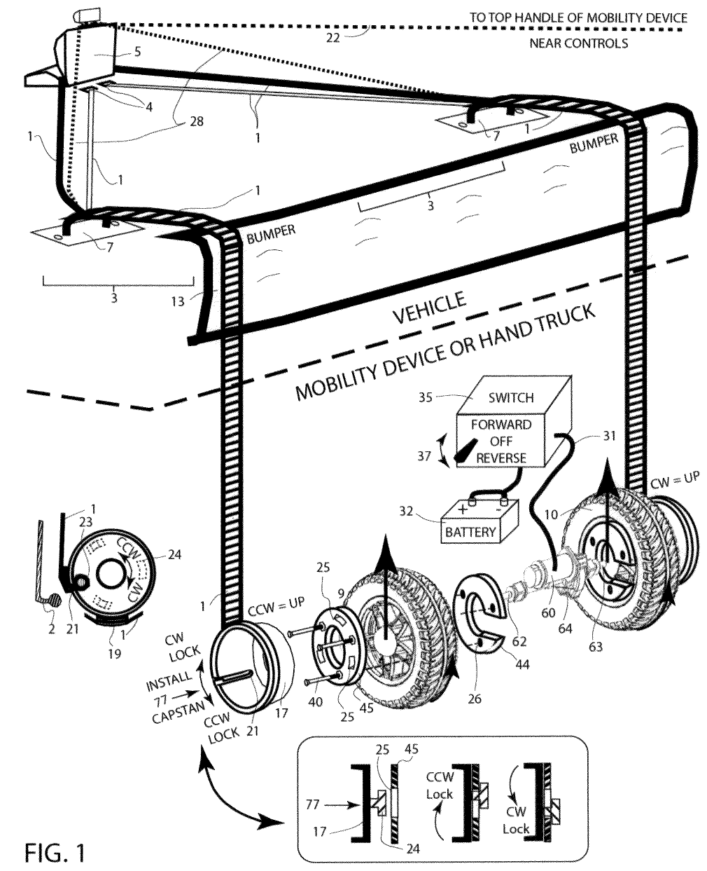

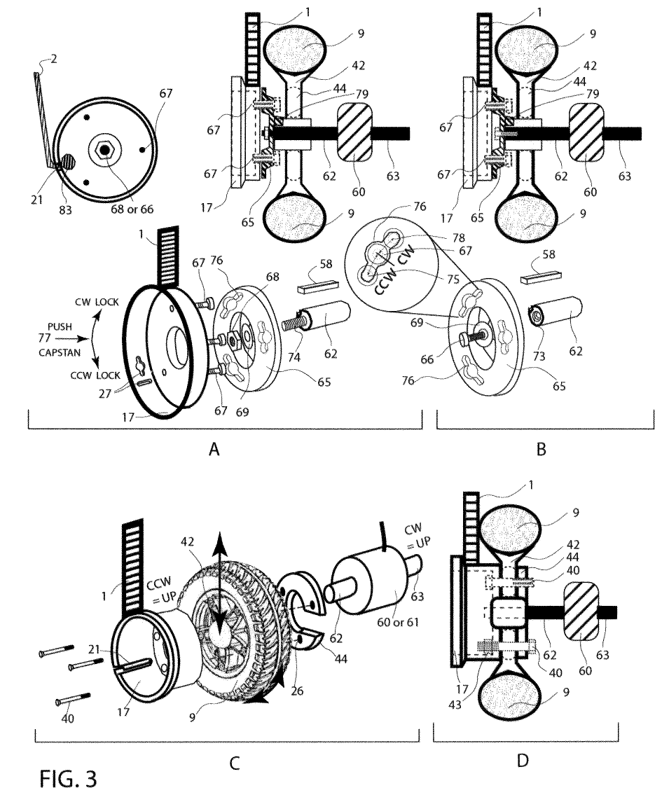

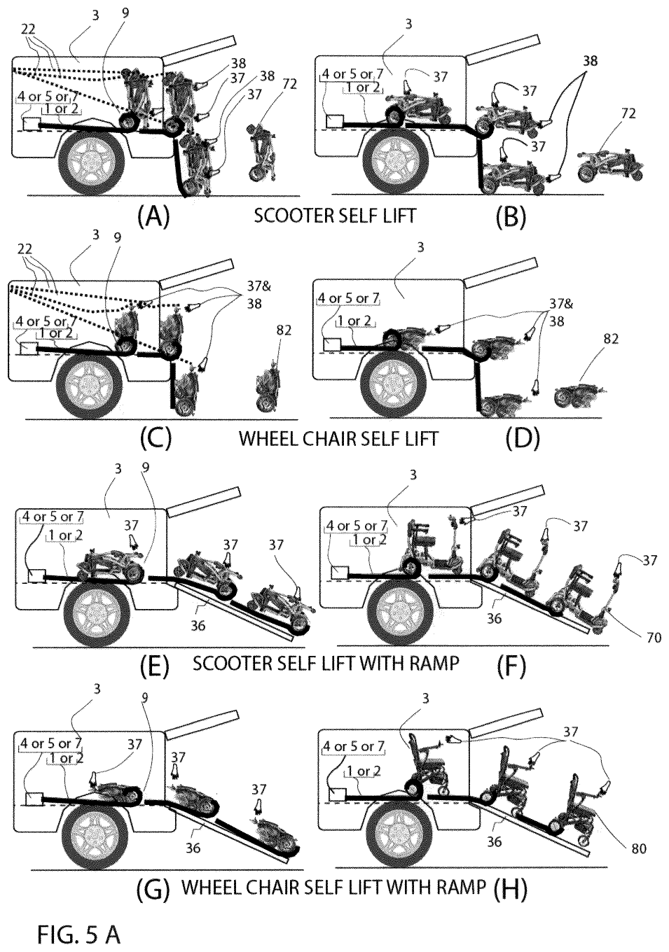

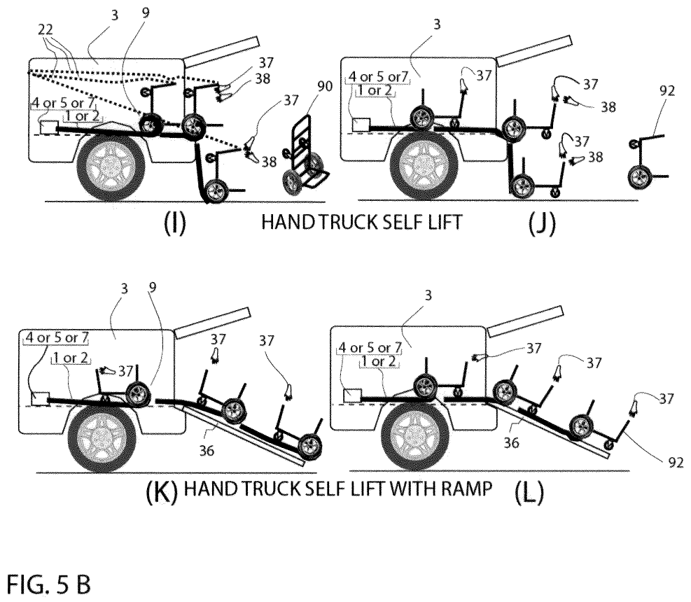

FIG. 1 shows the complete lifting system is comprised of a set of two tension members (1) which can be woven flat straps (1) or round cable or rope (2), capable of holding about 220 kg (100 pounds) each. Two tension members are needed since there is a differential (64) in the single motor (60) axles, so if one-wheel stops turning all power goes to other wheel, hence both wheels must be connected to tension members. Dual motors (61) need two tension members to maintain balanced lifting. These tension members are attached to the vehicle (3) on child car seat anchors (4) or by wrapping them around the seat (5), or by special anchors attached to the vehicle floor (7). These tension members are spaced apart by approximately the outer width of the motor driven wheels (9,10). These tension members extend straight over the back bumper or tailgate (13) of the vehicle (3) and extend to the ground. The wheel diameter (9,10) is greater than the capstan (17) diameter, so bungee cords (28) or springs are used to maintain tension when the mobility device is moving on its wheels in the vehicle. The tension members are then attached to the mobility device drive wheels (9,10) or the capstan (17) attached to the wheels. This tension member quick attach and release attachment can take many forms. The first form shown as (19) is achieved with either loop and pile (“Velcro”) or magnet and latch plate, which can be easily attached and detached to either the wheel (9,10) directly or the capstan (17). The second form is to fold woven ribbon (1) which is then slid into a slot in the capstan (21) with a retainer (23) to keep the folded strap from pulling out. The third form shown is to put a knot in the rope and slide it into slot (21) in the capstan. Slot (21) is shown to come from the capstan outer edge. Attachments that use key slots for rope and slots for straps (FIG. 3-(27)) are also options. All these attachments are easy to connect and disconnect. Alternative attachments of the tension members (1) to the wheel (9) or capstan (17) are anticipated. A third tension member (22), which is not used for lifting, but to stabilize the top of the folded mobility device or hand truck (72, 82 & 92) during the lift and may be attached to the top of the seat, under the headrest or other high location in the vehicle and the top of the mobility device being lifted. Tension member (22) is also shown in FIG. 5-A panels (A & C) and FIG. 5-B panel (I), where it stabilizes the folded mobility device or hand truck (72, 82 & 92).

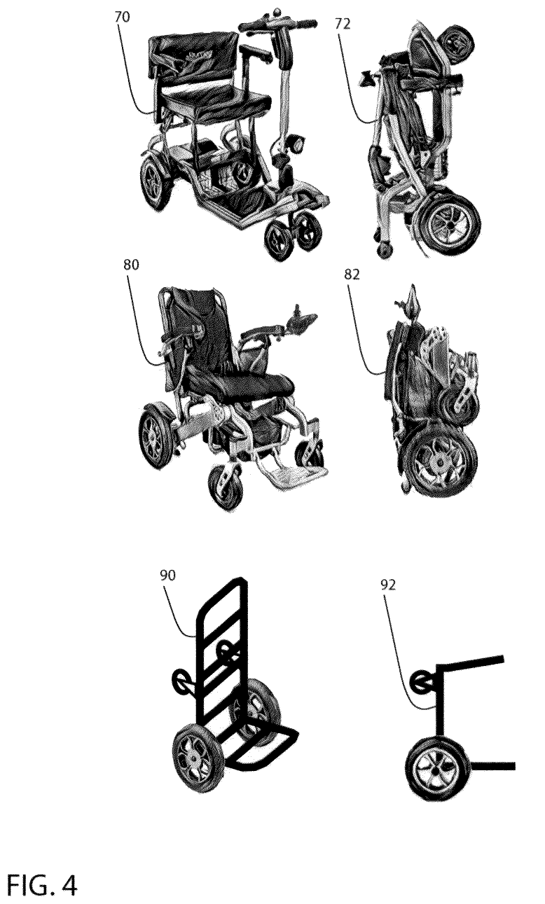

Once the tension members (1) are connected at both ends to the vehicle (3) the folded or unfolded scooter (70,72) and wheel chair (80,82) or hand truck (90,92) which are shown in shown in FIG. 4. Then these scooters, wheelchairs and hand trucks from FIG. 4 can be lifted into the vehicle using their motor (60,61) driven wheels (9,10), which are powered by the onboard battery (32) via the controller (35) and forward and reverse switch (37) as shown in FIG. 1, in the dashed line separating the vehicle from the mobility device.

There is another way to attach the straps (1) and rope (2) to the capstan so they are not removable. Then using a cam and twist lock device (77) to remove the capstan (17) and tension members (1 & 2) together from the mobility device. This has the advantage of removing the capstans (17) while not lifting or lowering the mobility device, so the width of the mobility device is not increased. The inset in FIG. 1 shows back plate (45) with through holes (25) spaced from 60 to 120 degrees apart. The cam lugs (24) on the capstan (17) then pass through the mating holes in the backing plate and are rotated clockwise or counter clockwise to lock the capstan (17) to the backing plate (45). You will note that during lifting or descending the near wheel (9) and far wheel 10 rotate in the same direction. If one wheel (9) is rotating counter clockwise then the far wheel (10) is rotating clockwise and vice versa. The cam and twist lock is designed, so the capstan (17) and backing plates (45) can be mounter on either the near (9) or far wheels (10) using countersunk bolts (40) in backing plate (45) and threaded plate on the other side of the spokes (44). Axle mounting of backing plate (65) will be shown in FIG. 3. This has advantages in manufacture of same parts (17 & 65) and allows mobility devices to be loaded and unloaded either forward or backwards, by only reversing motor (60) or motors (61) using reversing switch (37). Loading backwards places the center of gravity further from the tension members (1 or 2) so person loading needs to apply a small force (38).

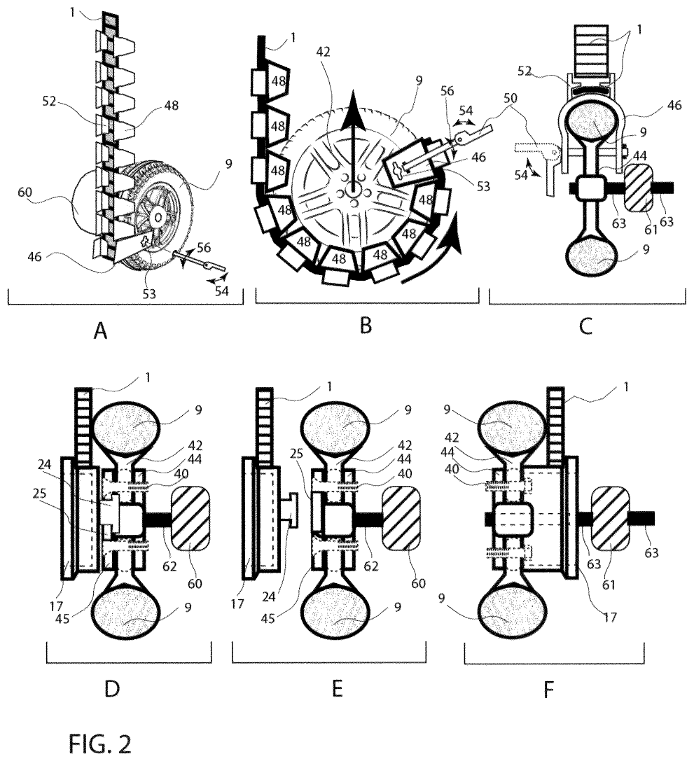

The FIG. 2 panels (A, B & C) show a special tire clamp (46) segments (48) that clip (52) onto the strap tension member (1). Clamp (46) slips over the tire (9) and is held in place by a lever pin (50) that is inserted through holes (53) in clamp (46) and rotated (56) 90 degrees, then lever locked (54). Strap (1) is bonded or riveted to Clamp (46), then segments (48) are held on the strap by tab (52). The vertical sections above tab (52) on segments (48) now form a guide for additional wraps of strap. This method of using the tire for lifting tension members has two potential limitations. The first clearance between the tire and fender may not be sufficient. The second is because of the tire's large diameter the drive motor (60,61) may have insufficient torque to raise the weight of the mobility device (70, 80 & 90) at the slow speeds required.

FIG. 2 panels (D & E) show a removable capstan (17) which is cam and twist locked to a wheel spoke mounted backing plate (45) bolted to threaded plate (44) which is on the other side of the wheel spoke (42). Panel (D) shows capstan (17) in place and panel E shows capstan (17) separated from backing plate (45). Camming lug (24) on the capstan (17) goes into cam hole (25) on backing plate (45) locking them together for forward and reverse motion needed for right and left wheels. Once lifting or lowering is over the capstans are remove so no width is added to the mobility device while in use. FIG. 2 panel (F) shows placing the capstan (17) on the inside or motor side (60,61) of the wheel and adds no mobility device width. The capstan (17) is bolted directly through the spoke (42) with bolts (40) where nuts (43) could be used, or plate (44) threaded. Alternatively, the bolts may be threaded into the backing plate (44) then pass through the rim spokes (42) and capstan (17) and be secured by nut (43). More attachments onto the wheel (44) and tire (9,10) are possible but not shown here. This method of using inside mounted wheel capstan (17) on the tire (9) for lifting tension members has the potential limitation that there is not enough clearance between the motor (60,61) and capstan to allow placement in that location.

FIG. 3 panels (A & B) shows the demountable capstan cam and twist locked to a back plate (65) which is attached to an extended threaded axle (74) with nut (68) and washer (69) or to a internally threaded axle (73) with a bolt (66) and washer (69). Back plate (65) has a tab (79) that engages in the key slot in the axle (62) in front of the square key (58) to assure the back plate (65) rotates with the axle (62). The cam and twist locks shown uses large round headed bolts (67) which come through the center cutout (76) and then the capstan (17) rotated to engage the clockwise (78) or counter clockwise (75) positions. There is a slight detent, which keeps the capstan (17) engaged until it is intentionally twisted for disengagement from the back plate (65). Alternative tension member (1,2) to capstan (17) fastening options for are slot, and key hole (27). FIG. 3 Panels (C & D) shows the details of the permanent attachment of the capstan (17) to the wheel spokes (42) and cross section of the capstan (17) to the spokes (44) via bolts (40) with or without nuts (43) if plate (44) is threaded. The motor for each wheel (60) and both wheels driven by one motor (61) on axles (62, 63). This makes the mobility device wider by about 3 cm (1.5″).

Shown in FIG. 4 are the mobility devices unfolded for use and folded for airline and car transport. The unfolded scooter (70) and wheel chair (80) can have one end lifted by the onboard motor if they cannot be folded. This would require the other end to be lifted by a person, requiring a greater lifting force. The folded scooter (72), wheel chair (82) and hand truck (92) can be self-lifted by the wheel motors with only a small balancing force added by a person.

FIGS. 5-A & 5-B shows the lifting sequence into the vehicle with wheels (9,10) or capstans (17) or pulling on the tension members strap/rope (1, 2) thereby raising the heaviest part of the mobility device (70, 80 or 90) into the vehicle. FIG. 5-A, in panels (A, C & I) show the device lifted with the center of gravity close to the tension member, so the guiding forces applied by the person (38) are a minimum. In FIG. 5-A & B panels (A, B, C, D, I & J) the activating the switch (37) must be activated while balancing the mobility device (70, 80 or 90) with a small force (38) of about 4 kg (9 pounds) while the tension members (1, 2) carry 14 kg (30 pounds) each making the force exerted by the person (38) only a fraction of the mobility device's 28 kg (61 pounds). Actual support needed depends on mobility device weight and configuration. Once in the vehicle (3) the mobility device wheels (9,10) move the mobility device (70, 80 or 90) into the interior of the vehicle (3) or the vehicles trunk. In FIG. 5-A panels (C & D) and FIG. 5-B panels (I & J) the activating the switch (37) and balancing the mobility device (38) are done at one location. In FIG. 5-A & B panels (B, D & J) show the device lifted with the center of gravity far from the tension member, so the guiding force applied by the person (38) are now greater, since the person is lifting the lighter end of the mobility device (70, 80 or 90).

In FIG. 5-B the activating the switch (37) must be activated while balancing the hand truck (90) with a small force (38) of about 10 kg (22 pounds) while the tension members (1) carry 28 kg (61 pounds) making the force exerted by the person (38) up to half of the hand trucks (90) weight. Once in the vehicle (3) the mobility device wheels (9) move the hand truck into the interior of the vehicle (3) or the vehicles trunk.

FIG. 5-A & B panels (E, F, G, H, K & L) show the lifting sequence using a ramp set (36). The wheels (9,10) or capstans (17) pulling on the tension members (1, 2) thereby raising the hand truck device (90) into the vehicle with the ramp eliminating any balance load from the loading person. The mobility device (70, 80 or 90) does not need to be folded if the vehicles cargo space is adequate. In FIG. 5-A & B panels (E, F, G, H, K & L), the activating the switch (37) must be activated with the ramp eliminating the need for a balancing force (38) provided by ramp (36). Once in the vehicle (3) the mobility device wheels (9,10) move the mobility device (70, 80 or 90) into the interior of the vehicle (3) or the vehicles trunk.

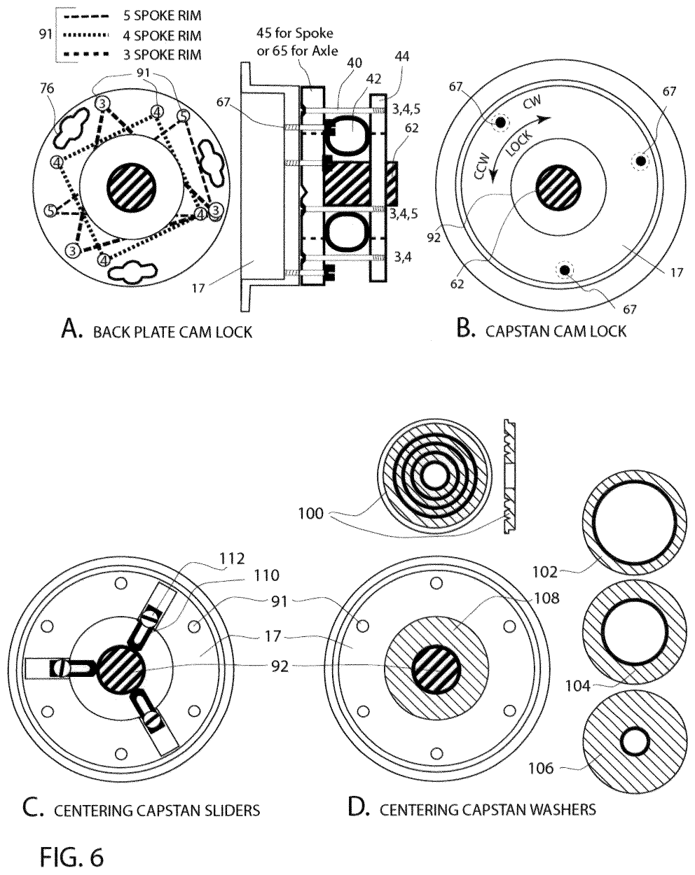

FIG. 6 shows the centering of each capstan on the wheel hub. The capstan must be centered on hub of the wheel before the bolts (40) which hold the capstan (17) or spoke mounted backing plate (45) to the wheel spokes (42) are tightened or axle mounted backing plate (65). FIG. 6 panel (A) shows the bolt patterns marked then machined in the capstan (17) to accommodate 3,4 and 5 wheel spoke patterns. With a large center hole using these bolt patterns will allow the capstan (17) or backing plates (45 or 65) to be centered before the countersunk bolts (40) in holes (91) are tightened. This hole pattern can accommodate 3, 4, 6 and 8 spoke wheel rim configurations, which are most common and allow for visual centering. Locations to drill these bolt holes are molded into the part, so holes needed may be drilled to fit each spoke configuration as needed. FIG. 6 panel B shows short round head bolts (67) the capstan (17) are passed through cam holes (76) in backing plate (17) which is then twisted to engage either clockwise or counter clockwise.

Each mobility device uses wheels with different hub diameters. To accommodate hubs ranging from 2.5 cm to 7 cm (1 in. to 2.5 in.) the capstan (17) shown in FIG. 6 panel (C) which includes three adjustable fingers (110) that can be slid in three grooves and secured with screw (112) in the base of the capstan (17) set 120 degrees apart. Sliding the fingers in the grooves allows the capstan to be centered on different diameter hubs. Once centered on the actual hub, the fingers can be locked with the three screws (112) shown. Detents can be made in the grooves to facilitate their holding, and rulers on the fingers to show the they are all equally extended, assuring the capstan is centered before bolting. FIG. 6 panel (D) shows a variation that uses a center washer with knockouts for various diameter hubs. The drive axles are shown as (92). Different knockouts are shown in (102,104 &106). Once the capstan (17) is centered it can be secured to the wheel with the appropriate fasteners through bolt holes (91).

1. An electric mobility device self-lifting system comprised of wheel or axle mounted capstans on either side of both drive wheels, tension straps/ropes that are fixed at one end to the interior of the vehicle with slack removal and the other end with easy attachment and release to the mobility devices drive wheel capstans that are driven by the devices own battery and electronics forward and reverse controls so the wheel motors wind/unwind the two tension members to lift or lower the bulk of the mobility devices weight into or out of a vehicle with minimal lifting and balancing forces by the person loading or unloading the mobility device.

2. An electric mobility device self-lifting system comprised of wheel or axle mounted capstans on either side of both drive wheels, tension straps/ropes that are fixed at one end to the interior of the vehicle with slack removal and the other end with easy attachment and release to the mobility devices drive wheel capstans that are driven by the devices own battery and electronics forward and reverse controls so the wheel motors wind/unwind the two tension members to lift or lower into or out of a vehicle using ramps so no lifting force is needed from the loading person, just activation of the forward and reverse controls for loading or unloading.

3. A motor-powered hand truck folded to reduced height to allow self-lifting of packages into a vehicle.

4. According to claims 1 and 2 with a removable capstan mated to a wheel, spoke or axle mounted back plate using a cam, lever or button lock mechanism which allows a single capstan to be mounted on the outside of the mobility device's right and left drive wheels for both clockwise and counter clockwise rotation.

5. According to claims 1 and 2 with an additional non lifting tension member to stabilize the top of a folded mobility device going from the high point in the vehicle, under seat headrest, to the top of the mobility device while the two main tension members are being wound up or down on the motor driven wheel capstans eliminating the need for user applied force.

6. According to claims 1 and 2 a means to center the capstan or demountable capstan back plate assembly on either the inside or outside of the drive wheel before being bolted, so the capstan is concentric with the wheel axle or center hub, such as adjustable screws, sliding tabs, centering washers, or bolt pattern centering.

7. According to claims 1 and 2 with tension member consisting of flat straps, thin wire ropes, round ropes, and a means to take up slack when mobility device rolls on wheel which are larger in diameter than capstan.

8. According to claims 1 and 2 simple means of attaching of attaching and detaching tension members to and from the capstans, such as hook and loop (Velcro), a magnet and catch or a flat slot for straps folded flat with inside keeper or a key slot to put a rope knot through.

9. According to claims 1 and 2 where the driven tires are used for lifting by using an easily attached and detached set of clips to attach, hold and center the tension straps/ropes on to the mobility device tire while creating a guide for tension straps/ropes beyond the clips, turning the tire into a capstan.
